(19) United States
(12) Patent Application Publication
(10) Pub. No.: US 2015/0229026 A1
(43) Pub. Date: Aug. 13, 2015

(54) ANTENNA ELEMENT AND DEVICES THEREOF

(71) Applicant: P-WAVE HOLDINGS, LLC, Los Angeles, CA (US)

(72) Inventor: Bjorn Lindmark, Stockholm (SE)

(21) Appl. No.: 14/427,368

(22) PCT Filed: Oct. 11, 2013
(86) PCT No.: PCT/US2013/064617

§ 371 Date: Mar. 11, 2015

Related U.S. Application Data
(60) Provisional application No. 61/714,055, filed on Oct. 15, 2012.

(51) Int. Cl. H01Q 13/10; H01Q 21/06

(52) U.S. Cl. CPC H01Q 13/10; H01Q 21/064

(57) ABSTRACT

The present invention relates to an antenna element comprising a substantially planar conductive disc having at least four slots arranged symmetrically in relation to a central rotational axis perpendicular to the disc, wherein each slot extends from a circumference of said disc radially inwardly toward the central axis and has an associated feed point located at its associated slot, and radially opposite feed points are arranged to be fed with common radio frequency signals which are substantially in phase and with equal amplitude such that the radiation from each slot is in phase and of equal amplitude so that the antenna element radiates along the central axis. Furthermore, the invention also relates to a multiband antenna unit, an antenna array, and a broadband antenna system.

### BACKGROUND OF THE INVENTION

1. Field of the Invention

The present invention relates to a broadband antenna element, a broadband antenna unit, an antenna array, and a broadband antenna system.

2. Description of the Prior Art

Multiband broadband antenna systems are antenna systems providing wireless signals in multiple radio frequency bands, i.e. two or more bands. They are commonly used and are well known in wireless communication systems, such as GSM, GPRS, EDGE, UMTS, LTE, and WiMax systems.

These types of antenna systems generally include a plurality of radiating antenna elements arranged to provide a desired radiated (and received) signal beamwidth and azimuth scan angle. For broadband antennas it is desirable to achieve a near uniform beamwidth that exhibits a minimum variation over the desired azimuthal degrees of coverage. Such broadband antennas generally provide equal signal coverage over a wide geographic area while simultaneously supporting multiple wireless applications. It is also necessary to provide a consistent beamwidth over a wide frequency bandwidth in modern wireless applications since transmission to and reception from the mobile stations use different frequencies. It is also desirable to have similar area coverage for different wireless services using a common antenna.

Document U.S. Pat. No. 6,930,650 (Gottl et al.) discloses a dual-polarized antenna arrangement having four antenna element devices each with a conductive structure between opposite antenna element ends. The antenna element devices are fed at the respective end of the four gaps.

Further, document U.S. Pat. No. 7,079,083 (Gottl et al.) discloses a multiband mobile radio antenna. Mentioned antenna comprises two or more dipoles elements arranged in front of a reflector and are adapted to transmit and receive in two different frequency bands. The distance between the antenna element structure, the antenna elements or the antenna element top of at least one antenna dipole antenna element for the higher frequency band is at a certain specified distance from the reflector.

However, mentioned prior art solutions have complicated mechanical structure which require high complexity die-cast metal parts. This means that mentioned antenna has a considerable weight. The antenna elements according to prior art are also cumbersome (large size) with its height.

### SUMMARY OF THE INVENTION

An object of the present invention is to provide a solution which mitigates or fully solves the problems of prior art solutions.

Another object of the invention is to provide an antenna solution which can made small but still have good impedance characteristics.

According to a first aspect of the invention, the mentioned objects are achieved with a broadband antenna element for an antenna system, said antenna element comprising a substantially planar conductive disc having at least four slots arranged symmetrically in relation to a central rotational axis perpendicular to said disc, wherein each slot extends from a circumference of said disc radially inwards towards said axis and has an associated feed point located at its associated slot; and radially opposite feed points are arranged to be fed with common radio frequency signals which are substantially in phase and with equal amplitude such that the radiation from each slot is in phase and of equal amplitude so that said antenna element radiates along said axis.

According to a second aspect of the invention, the mentioned objects are achieved with a multiband antenna unit comprising at least one antenna element according to the invention and at least one second broadband antenna element arranged above or below said first broadband antenna element; and further comprising at least one planar parasitic element arranged between said first and second broadband antenna elements.

According to a third aspect of the invention, the mentioned objects are achieved with an antenna array comprising a plurality of multiband antenna units according to the invention and a plurality of first broadband antenna elements according to the invention, and said multiband antenna units and said first broadband antenna elements are alternately arranged in a row so that a distance d_{AE} between the centre of a first antenna element and an adjacent antenna unit in said row is constant.

Furthermore, the present invention also relates to a broadband antenna system.

The present invention provides a solution having a planar disc which allows the manufacturer to use printed circuit boards (PCBs) for the feed network which is convenient from a matching point of view. Also, the active impedance (the impedance seen when the two slots of the same polarization are excited simultaneously in phase and of equal magnitude) of each slot can be tuned to 100 ohm impedance which allows an easy match of the two feeds to a common 50 ohm transmission line when providing broadband operation in two orthogonal polarizations.

The present antenna element can also be made small in size which reduces the size and weight of antenna installations in the field.

Other embodiments of the antenna element above are further described herein.

Further advantageous and applications of the present invention can be found in the following detailed description of the present invention.

### BRIEF DESCRIPTION OF THE DRAWINGS

The appended drawings are intended to clarify and explain different embodiments of the present invention.

FIGS. 1A-1C show three different embodiments of an antenna element according to the present invention.

FIGS. 2A and 2B show top and side views of a single band broadband frequency coverage antenna element according to an embodiment of the invention.

FIGS. 3A and 3B show top and side views of an antenna element according to another embodiment of the present invention.

FIGS. 4A and 4B show top and side views of an antenna element with increasing width slot structure and symmetrically arranged cut outs.

FIG. 5 shows an embodiment of an antenna array according to the present invention.

### DETAILED DESCRIPTION OF THE INVENTION

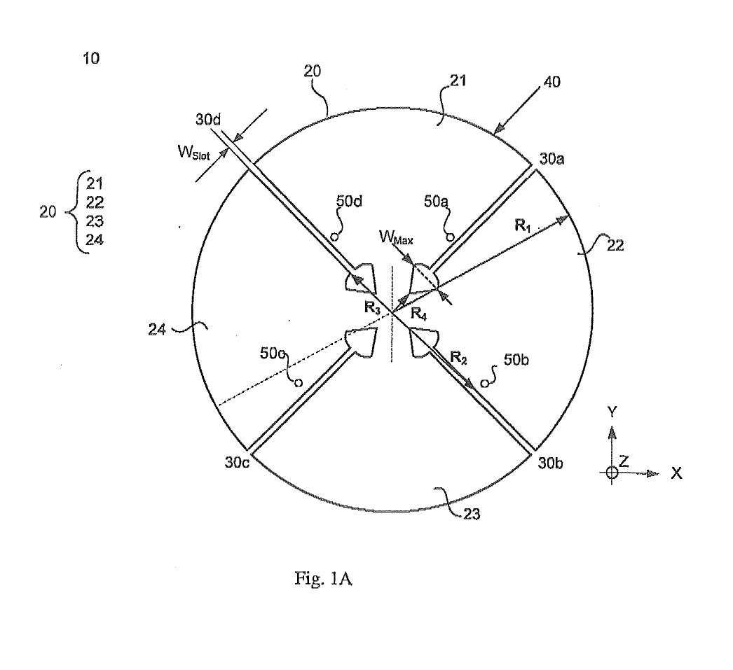

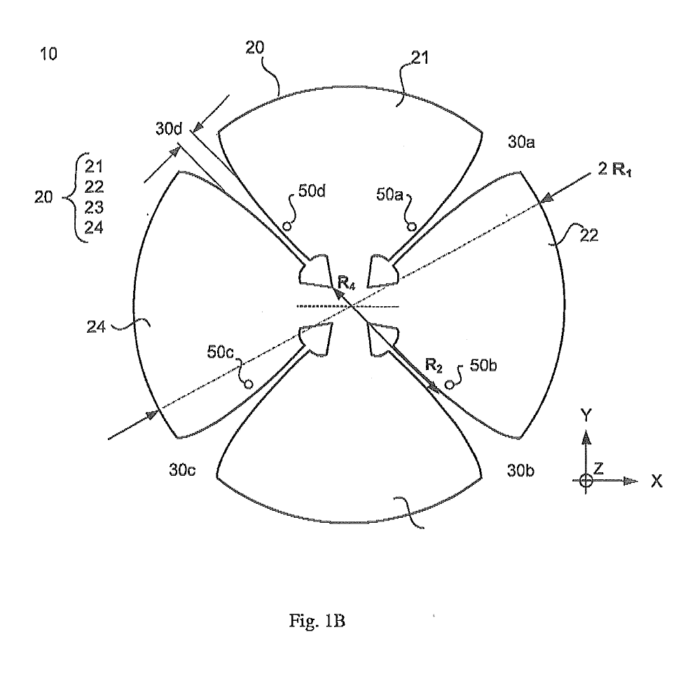

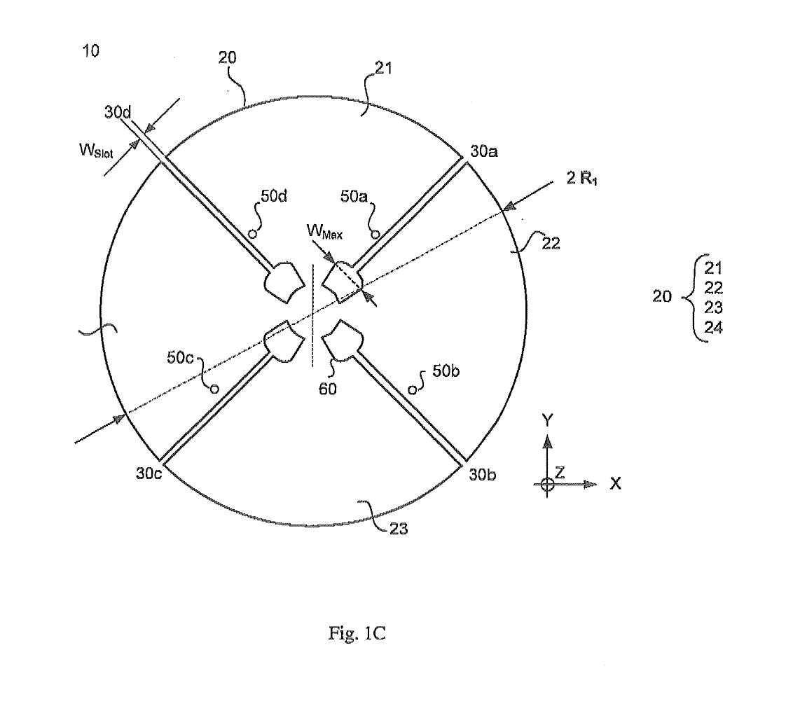

The present invention relates to a broadband antenna element 10 generally represented in FIGS. 1A-1C for antenna systems. The present antenna element includes a substantially planar conductive disc 20 that has a circumference 40 and a central part. The antenna element further includes at least four slots 30a, 30b, 30c, 30d arranged symmetrically in relation to a central rotational axis Z which is perpendicular to the disc 20. Hence, the slots are equally spaced circumferentially on the disc, thereby portioning the disc into four equal quadrants 21, 22, 23, 24 in a configuration with four slots. This means that the number of portions is dependent on the number of slots arranged on the disc 20.

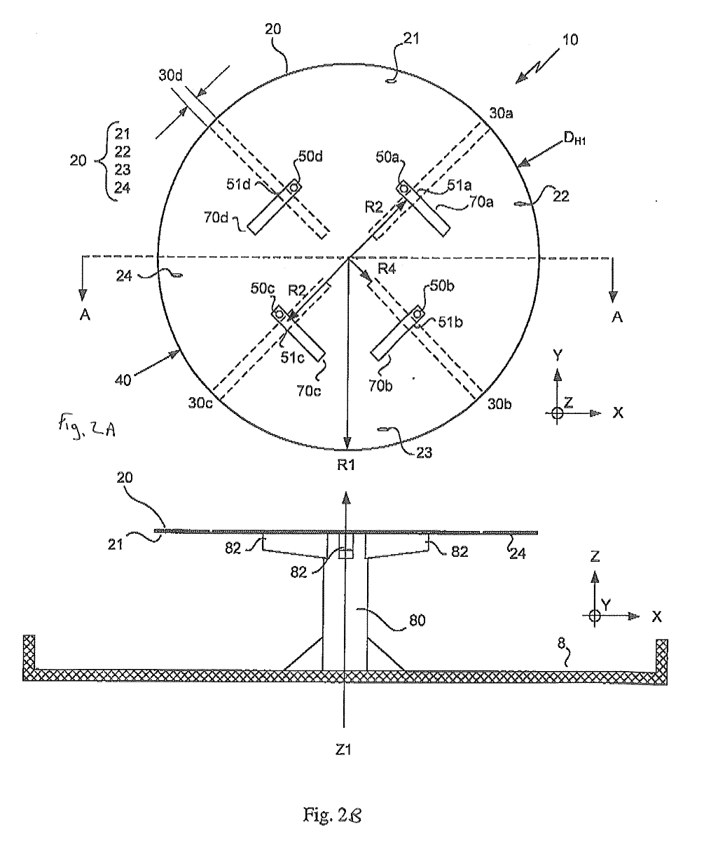

Each slot 30a, 30b, 30c, 30d of the disc extends from the circumference 40 of the disc 20 radially inwardly, and along the plane of the disc 20 toward the axis Z. Each slot 30a, 30b, 30c, 30d has an associated feed point 51a, 51b, 51c, 51d, shown in FIG. 2A, which is located at its associated slot 30a, 30b, 30c, 30d. The present antenna element is arranged such that radially opposite feed points (51a-51c and 51b-51d in FIG. 2A) are arranged to be fed with common radio frequency signals which are substantially in phase and with equal amplitude such that the radiation from each slot 30a, 30b, 30c, 30d is in phase and of equal amplitude so that the antenna element 10 radiates along said axis Z1. Hence, radially opposite feed points means a pair of feed points that are arranged on each side of the central axis Z. For example, FIG. 2 shows two radially opposite feed point pairs 51a-51c and 51b-51d associated with feeding termination points 50a, 50c and 50b, 50d, respectively.

As is well known to those schooled in the art, an antenna with multiple feed points will have active impedance, also known as driving point impedance. Considering a first slot (30a) and a second slot (30c) of the antenna element 10, if those slots are excited with the same phase and magnitude, there will be radiation along the axis Z. In order to match the antenna to a desired impedance, it is important to consider the mutual coupling between the first and second slots. The relevant impedance is then referred to as active or driving point impedance calculated as follows: if the impedances of the two respective slots 30a and 30c are Z11 and Z22, respectively, and the mutual impedance is Z12=Z21, the active (or driving point) impedance of slot 30a given feed current I1 and I2 is: Z1d=Z11+Z12*12/11. When I1=I2 (equal phase and magnitude) the active impedance is simply: Z1d=Z11+Z12.

According to an embodiment of the present invention shown in FIG. 1A, the circumference 40 of the disc 20 is located at a first radial distance R₁ from the rotational axis Z, and each feed point is located at a second radial distance R₂ from the rotational axis Z. The relation between the first and second radial distances is such that the second radial distance R₂ is less than the first radial distance R₁, i.e. R₂<R₁. Preferably, the second radial distance R₂ is less than 0.5 times the first radial distance R₁, i.e. R₂<0.5·R₁. A smaller R₂ provides a smaller real part (resistance) of the slot impedance. This can be used to achieve the desired active impedance.

Moreover, according to an embodiment of the present invention each slot 30a, 30b, 30c, 30d extends radially inwardly and ends at a fourth radial distance R₄ from the rotational axis Z of the disc 20 (see FIG. 1A-1C), wherein the fourth radial distance R₄ is less than the second radial distance R₂, i.e. R₄<R₂. An example of the antenna element 10 includes the following setup: R₁=32 mm, R₂=13 mm, R₄=6.5 mm for operation in the frequency band 1710-2690 MHz.

Generally, the total length of the slots (i.e. R₁-R₄) affects the frequency of operation of the radiating antenna element 10. For example, for operation in the frequency band from 1710 MHz to 2690 MHz, a suitable length of each slot is 20 to 35 mm, which corresponds to 0.15 to 0.25 wavelengths at the center frequency for 2200 MHz. Further, the width of the slots may be varied to match the antenna impedance. A wider slot increases the reactance of the antenna element, hence making it more inductive, while a narrower slot will make it more capacitive. It is also possible to use varying slot width all the way to the circumference of the disk 20, e.g., exponential slot width taper, linear step taper or linear slope taper.

It has also been realized that each slot may have a symmetrically shaped widening 60. Each widening 60 starts from a third radial distance R₃ from the rotational center axis Z and extends radially inwards towards the center of the disc 20. Each widening 60 may start from a radial distance that is less than the second R₂ radial distance which defines the radial location of the feeding termination points 50a-50d. Depending on the radius R₁ of the disc 20 and the position of the transmission lines 30, 32 (from the feed network), it may be impossible to extend the slots as far to the center of the disc 20 as desired from an antenna impedance point of view. It may then be preferable to increase the effective length of the slots by making them wider at the inner end closest to the center of the disc 20. Hence, according to yet another embodiment of the invention each widening 60 has a largest width w_{W}_{_{—}}_{Max} that is c_{Slot} (a constant) times the width w_{Slot} of each slot. In this particular embodiment it is assumed that the slots have a minimum width w_{Slot}.

FIGS. 1A-1C show three different embodiments of the antenna element 10 according to the present invention. It is noted that the disc 20 in this case has four symmetrically arranged slots each slot with the associated widenings 60, which are pointed in shape in the radial inwards direction. This allows the maintaining of the slot feed at the feed points 50a-50d while extending the effective length of the slot.

As noted, the slots divide the disc into four portions 21, 22, 23, 24, and the slots in FIGS. 1A and 1C have constant width while the slots in FIG. 1B are wider at the circumference 40 of the disc 20. It is further noted that the present antenna element 10 has the four feeding termination points 50a, 50b, 50c, 50d arranged adjacent to its associated slot 30a, 30b, 30c, 30d. The distance perpendicular in relation to the radial direction between a feeding termination point and its associated slot d_{FP} depends on necessary impedance matching. The total impedance Z_{—}1 seen at the slot (30a) is the sum of the active impedance of the slot Z_{—}1 and the series impedance presented by the short circuited stub (generally short transmission line used in microwave engineering to match circuits or used as filter resonators) ending in feeding termination point (50a), i.e. Z_{—}1=Z_{—}1d+Z_stub. If the distance d_{FP} is very small, the series impedance is close to zero and Z_{—}1≈Z_{—}1d. However, if the distance d_{FP} is increased or if the termination is changed from a short circuit to an open circuit, the value of Z_stub changes and this may provide a better impedance matching of the antenna element (the cross-section area of the slots may also be varied for impedance matching). Hence, preferably the distance d_{FP} is less than λ/4 (λ wavelength) of the lowest operating frequency for the antenna element 10, i.e. d_{FP}<λ/4.

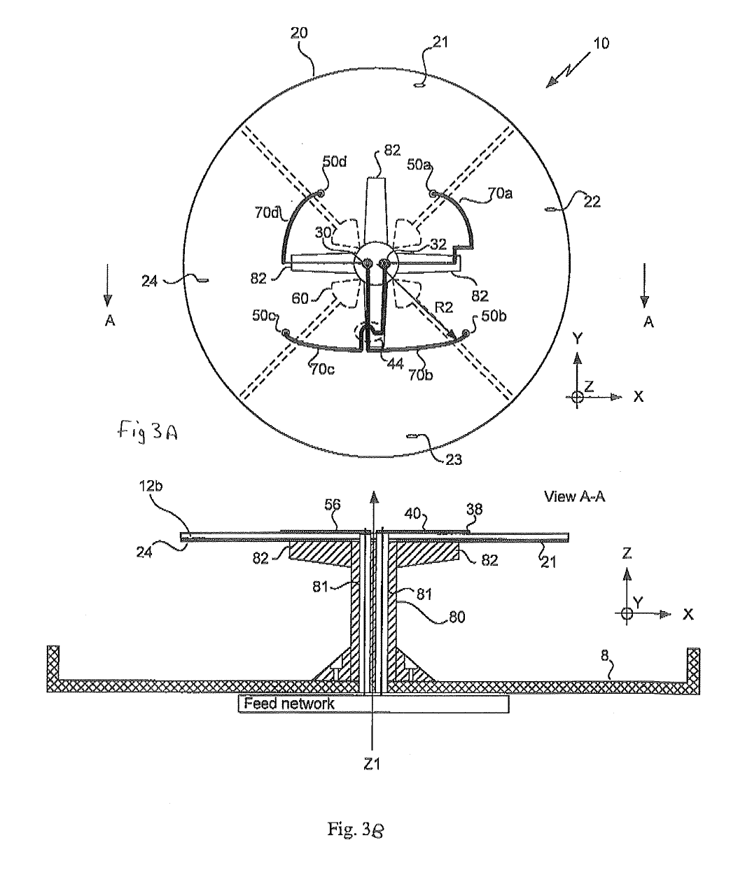

FIGS. 2A-3B show different embodiments of a single frequency antenna element 10 with associated support structures 80. With reference to FIGS. 2A and 2B, the antenna element 10 has the conductive disk 20 positioned and supported above a conducting reflector 8 by the support structure 80. The support structure 80 is in this embodiment symmetrically arranged around and extends along the axis Z and is arranged to support the antenna element 10 with a predetermined distance over the reflector 8 associated with the antenna element 10. Optionally, the support structure 80 may have in its interior one or more channels 81 extending at least in part along the axis Z. The channels 81 enclose (e.g. coaxial) transmission lines 30, 32 connected to (strip) guides 70a, 70b, 70c, 70d, which connect the feeding termination points 50a, 50b, 50c, 50d to the feed network of the antenna system.

Furthermore, the conductive disk 20 is portioned into the four equal quadrants, 21, 22, 23, 24, generally separated radially by the oriented slots 30a-30d therebetween. Radio Frequency (RF) signals are coupled via a first pair of two separate radio signal guides 70a, 70c (e.g. strip lines or any other suitable signal guides) to a first pair of two radially opposite arranged slots 30a, 30c. The first pair of guiding means 70a, 70c may be two strip lines of substantially equal electrical length. Similarly, a second pair of two separate radio signal guides 70b, 70d has substantially equal electrical length coupled to a second pair of radially opposite arranged slots 30b, 30d.

FIGS. 3A and 3B show another embodiment of the present invention. The embodiment in FIGS. 3A and 3B has the support structure 80 with support arms 82 extending radially outwards from the center of the disc 20 and being arranged to hold the conductive disc 20 more securely over the reflector 8. Also in this case, a first pair of guides 70a, 70c is connected to a first transmission line 30 at a point close to the center of the disc 20, and a second pair of guides 70b, 70d is connected to a second transmission line 32. The two transmission lines 30 and 32 are in turn connected to a feed network of the antenna system, via suitable radio signal guides arranged within channels of the support structure 80. The feed network is in this case located below the reflector 8 as shown in FIGS. 3A and 3B.

In the embodiment shown in FIGS. 3A and 3B, the radio transmission guides are in the form of microstrip lines positioned on top of a dielectric support layer 12b, and the radio frequency transmission lines 30, 32 are in the form of coaxial transmission lines disposed within channels of the support structure 80 and connected to the feed network. Further, in the embodiment shown in FIGS. 3A and 3B, the conductive disc 20 has the same size as the dielectric support layer 12b, but it is also possible to have the disc 20 be larger than the dielectric support layer 12b.

It is preferable, but not necessary, to use different characteristic impedance for the strip lines 70b, 70d and the first transmission line 30 to avoid mismatch at their junction. For example, a characteristic impedance of 100 ohm for the strip lines 70b, 70d and a characteristic impedance of 50 ohm for the radio frequency guide 30 may be provided. This choice minimizes the wave reflection at the junction between the strip lines 70b, 70d and the radio frequency guide 30. Other choices of characteristic impedances are possible if this better matches the antenna impedance to the reference impedance of the antenna system. Similar requirements apply to the other strip line structure of guides 70a, 70c and radio frequency guide 32.

Further, the first pair of guides 70a, 70c extends from the first radio frequency transmission line 30 over a first pair of opposite arranged slots 30a, 30c. This will excite an electromagnetic field across the slots 30a, 30c which will propagate away from the antenna element 10 in a first linear polarization. The radial location of the feed points (where guides crosses the slots) R₂ affects the antenna impedance in such a way that a radial position closer to the center of the disc 20, i.e. a smaller value for R₂, and will provide a lower resistance while a position radially farther out on the disc 20 will increase the resistance.

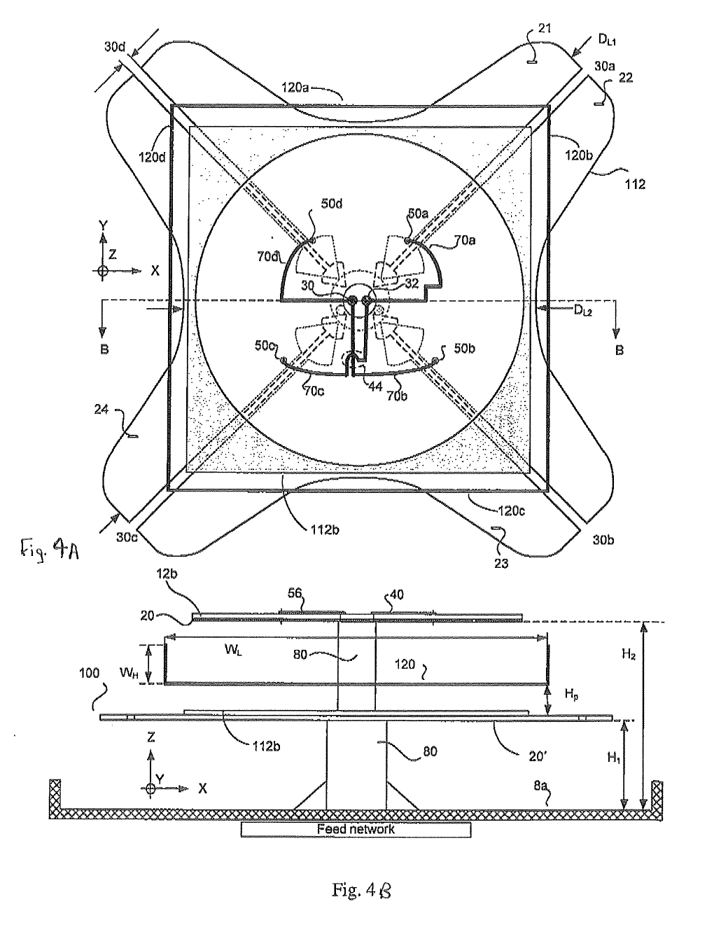

In order to avoid intersection between different guides, if they are not insulated (e.g. strip lines), an air bridge 44 may be implemented which is shown in FIGS. 3A-4B. Furthermore, it is desirable to maintain the same length (and phase relationship) of respective pairs of guides 70a, 70c and 70b, 70d which may be realised by adapting the length of individual guides, respectively.

The present invention further relates to a multiband antenna unit 200 comprising at least one first broadband antenna element 10 as described above and at least one second broadband antenna element 100 arranged above or below the first broadband antenna element 10 depending on the operating frequencies of the two antenna elements. An embodiment of such a multiband antenna unit is shown in FIGS. 4A and 4B.

The antenna unit 200 also includes at least one box-shaped parasitic element 120 arranged between the first 10 and second 100 broadband antenna elements (the parasitic element 120 is transparent in FIGS. 4A and 4B). Preferably, the first broadband antenna element 10 is arranged to radiate radio signals in a first frequency band f₁ and the second broadband antenna element 100 is arranged to radiate radio signals in a second frequency band f₂. The first frequency band f₁ is a higher frequency band than the second frequency band f₂, i.e. f₁>f₂ which means that the first and second elements together form a dual broadband antenna unit.

To control azimuth beamwidth of the first higher frequency antenna element 10 and the impedance of the second lower frequency element 100 a parasitic element 120 having four sides 120a-d is positioned at a distance above (in a positive Z direction) a conducting plate 112 of the antenna system as shown in FIGS. 4A and 4B. The parasitic element 120 will typically affect the impedance of the first higher frequency antenna element and at the same time the radiation of the second lower frequency antenna element acting as a reflector for the latter antenna element. It is preferable that the width of parasitic element 120 is greater than the size of the higher frequency antenna element, i.e. W_{L}>2R₁. The side dimension W_{L}and wall height W_{H} of the parasitic element 120 are chosen so as to achieve desired azimuth beamwidth for the first higher frequency antenna element. The parasitic element 120 can be constructed using several known methods, such as sheet metal or alternatively elevated conductive rods. Furthermore, the side dimension W_{L} of the parasitic element and the height Hₚ above the conductive disk 20 is chosen to provide a good impedance match for the lower frequency antenna element. It has been noted that parasitic element 120 could have a length W_{L} that is larger than λ/5 but less than λ/3 of the center operation frequency for the lower frequency antenna element, i.e. λ/5<W_{L}<λ/3, for good performance.

With reference to the embodiment of a dual broadband antenna unit in FIGS. 4A and 4B, the dual broadband antenna unit 110 includes a High Frequency Broadband Antenna Element (HFBAE) previously described as antenna element 10 positioned above a corresponding Low Frequency Broadband Antenna Element (LFBAE) previously described as broadband antenna element 100 having its dimensions scaled accordingly to provide effective operation in a desired frequency band generally lower in frequency than the frequency chosen for HFBAE operation. The LFBAE is constructed similarly to the HFBAE previously described.

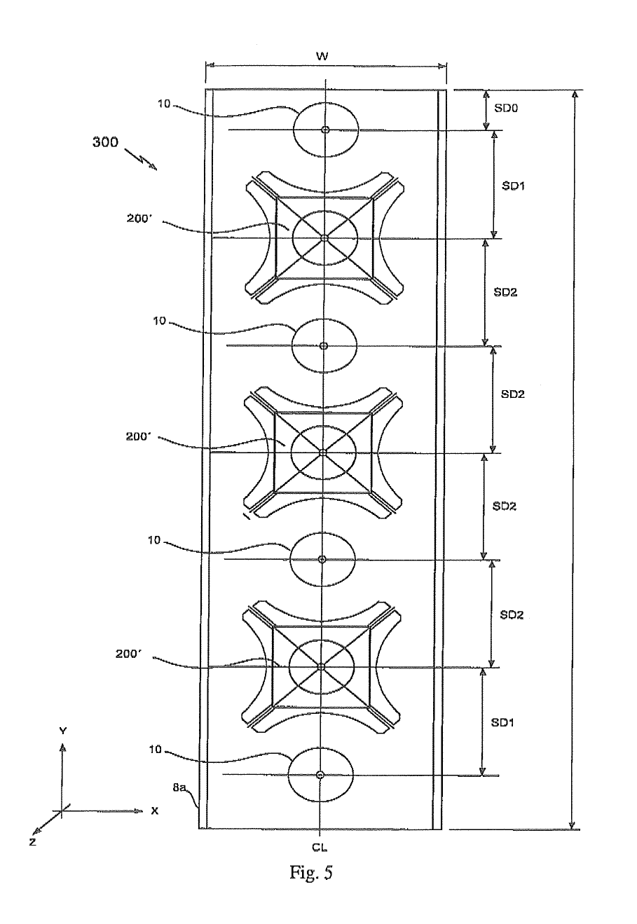

With continuing reference to FIGS. 4A and 4B, the LFBAE includes a conductive disc 20′ positioned directly immediately underneath a dielectric support layer 112b. The conductive disc 20′ can be made of a suitable metal disc cut from sheet metal, such as aluminium using any industrial process known to a skilled person. Similarly to the HFBAE, the conductive disc 20′ of the LFBAE is in this case divided into four quadrants 21′, 22′, 23′, 24′ (or leafs) by four slots 30a′, 30b′, 30c′, 30d′ with exception being that some portion of the metal leafs are not covered by the dielectric support layer 112b. It has been determined that complete coverage of metal leafs with dielectric support layer 112b is unnecessary and adds additional expense. It has further been determined that leaf edges away from slots 30a′, 30b′, 30c′, 30d′ can be cut out (scalloped) with a concave shape as this allows placement of the HFBAE nearby in a multiband antenna array as shown, for example, in FIG. 5. Consequently, as is shown in FIG. 4A, diagonal distance DL1 will be greater than scalloped (cut out) cross distance DL2 without detrimentally effecting antenna element performance.

As it can be seen in FIG. 4B, the LFBAE element is positioned at distance H₁ above reflector 8a (in a positive Z-direction) and can be supported with an appropriately configured center post support structure 80. The center post support structure 80 is provided with two sets of radio frequency guides, with corresponding pairs feeding the LFBAE and HFBAE radiators. The distance H₁ may have relation to the height Hₚ as 2Hₚ<H₁<6Hₚ according to an embodiment of the invention.

Even though a dual broadband antenna element structure has been described, the same designed principals can be applied to tri-band and more band antenna element systems.

Moreover, the invention also relates to an antenna array comprising a plurality of multiband antenna units 200 according to the invention and a plurality of first broadband antenna elements 10. The present antenna array is configured such that the multiband antenna units 100 and the first broadband antenna elements 10 are alternately arranged in a row so that a distance d_{AE} between the center of a first antenna element 10 and an adjacent antenna unit 200 in the row is constant.

With reference to FIG. 5, an embodiment of a dual broadband antenna array 300 according to the present invention will be described. In this non-limiting example, three antenna units each comprising a LFBAE and a HFBAE 200′, and four HFBAEs 10 are arranged alternately in a row, along the Y-axis (i.e. along longitudinal center line CL of the reflector 8a). Dimensions SD1 and SD2 are preferably equal so that the high frequency array has uniform spacing throughout the array. The distance SD0 is chosen based on the total length acceptable for the antenna and if possible set to a value near SD1. As well known to those schooled in the art, the dimensions SD1 and SD2 have to be chosen less than one wavelength to avoid the presence of multiple maxima, or grating, lobes in the vertical pattern. If the main beam of the antenna array is steered away from the horizontal plane, the distance has to be even smaller and a distance of 0.5 wavelengths will guarantee that there are no grating lobes for any steering angle. In practice, it is difficult to fit the antenna elements with such a small spacing and it was found that a value SD1=SD2=112 mm provides good performance for operation in the lower band 790-960 MHz and the higher band 1710-2690 MHz (as an example). In the lower frequency band, we thus have an array spacing of 224 mm, or 0.65 wavelengths at the center frequency 875 MHz. In the higher frequency band, the spacing is 112 mm, or 0.82 wavelengths at the center frequency 2200 MHz.

The above described antenna array may be incorporated in a broadband antenna system which is readily understood by the skilled person. It is also realized that a broadband antenna system may incorporate any of the antenna elements and antenna units according to the invention. The broadband antenna system is preferably adapted for transmitting and/or receiving radio transmission signals for wireless communication systems such as GSM, GPRS, EDGE, UMTS, LTE, LTE-Advanced, and WiMax systems

Finally, it should be understood that the present invention is not limited to the embodiments described above, but also relates to and incorporates all embodiments within the scope of the appended independent claims.

1. A broadband antenna element for an antenna system, said antenna element comprising a substantially planar conductive disc having at least four slots arranged symmetrically in relation to a central rotational axis (Z) perpendicular to said disc, wherein
each slot extends from a circumference of said disc radially inwards towards said axis (Z) and has an associated feed point located at its associated slot; and
radially opposite feed points are arranged to be fed with common radio frequency signals which are substantially in phase and with equal amplitude such that the radiation from each slot is in phase and of equal amplitude so that said antenna element radiates along said axis (Z).

2. The broadband antenna element according to claim 1, wherein said circumference is located at a first radial distance R₁ from said axis (Z), and each feed point is located at a second radial distance R₂ from said axis (Z), and said second radial distance R₂ is less than said first radial distance R₁.

3. The broadband antenna element according to claim 2, wherein said second radial distance R₂ is less than 0.5 times said first radial distance R₁.

4. The broadband antenna element according to claim 3, wherein each slot ends at a fourth radial distance R₄ from said rotational axis (Z), said fourth radial distance R₄ being less than said second radial distance R₂.

5. The broadband antenna element according to claim 4, wherein each slot has a symmetrically shaped widening starting from a third radial distance R₃ from said rotational axis (Z) and extending radially inwards, said third radial distance R₃ being less than said second radial distance R₂.

6. The broadband antenna element according to claim 5, wherein said third radial distance R₃ is greater than said forth radial distance R₄.

7. The broadband antenna element according to claim 5, wherein each widening has a largest width w_{Max} that is cₛₗₒₜ times the minimum width wₛₗₒₜ of a slot, where cₛₗₒₜ is a constant.

8. The broadband antenna element according to claim 1, wherein said slots have a constant width wₛₗₒₜ.

9. The broadband antenna element according to claim 1, further comprising a support structure symmetrically arranged around and extending along said rotational axis (Z) for supporting said antenna element with a predetermined distance over a reflector structure associated with said antenna element.

10. The broadband antenna element according to claim 9, wherein said support structure comprises, in its interior, at least one channel extending at least in part along said axis (Z), said channel being arranged to hold guiding elements for said feeding points.

11. The broadband antenna element according to claim 10, wherein said support structure comprises support arms extending radially outwards from said axis (Z), said support arms being arranged to hold said conductive disc.

12. The broadband antenna element according to claim 1, wherein each feed point is fed by an associated guiding element, said associated guiding element terminating at associated feeding termination points.

13. The broadband antenna element according to claim 12, wherein said guiding elements are stripe lines or coaxial cables.

14. The broadband antenna element according to claim 13, wherein each feeding termination point is located at a distance d_{FP} from its associated slot, said distance d_{FP} being less than λ/4 of the lowest operating frequency for said antenna element.

15. The broadband antenna element according to claim 1, wherein said antenna element is arranged to radiate radio frequency signals in two orthogonal polarizations.

16. The broadband antenna element according to claim 1, wherein
said disc is substantially circular, and/or
said disc has concave cut outs extending radially inwards from said circumference, wherein the cut outs are arranged between said slots.

17. A multiband antenna unit for a broadband antenna, comprising:
at least one first broadband antenna element and at least one second broadband antenna element arranged above or below said first broadband antenna element; and
at least one planar parasitic element arranged between said first and second broadband antenna elements,
wherein the first broadband antenna element comprises a substantially planar conductive disc having at least four slots arranged symmetrically in relation to a central rotational axis (Z) perpendicular to said disc, wherein each slot extends from a circumference of said disc radially inwards towards said axis and has an associated feed point located at its associated slot; and radially opposite feed points are arranged to be fed with common radio frequency signals which are substantially in phase and with equal amplitude such that the radiation from each slot-is in phase and of equal amplitude so that said antenna element radiates along said axis (Z).

18. The multi band antenna unit according to claim 17, wherein said parasitic element is box-shaped and extends parallel to said disc and has a substantially rectangular or quadratic shape.

19. The multiband antenna unit according to claim 18, wherein said parasitic element has a length W_{L} that is larger than λ/5 but less than λ/3 of the centre operation frequency for said second broadband antenna element.

20. The multiband antenna unit according to claim 17, wherein said first broadband antenna element is arranged to radiate radio signals in a first frequency band f₁ and said second broadband antenna element is arranged to radiate radio signals in a second frequency band f₂, said first frequency band f₁ being a higher frequency band than said second frequency band.

21. An antenna array comprising a plurality of multiband antenna units and a plurality of first broadband antenna elements wherein said multi band antenna units and said first broadband antenna elements are alternately arranged in a row so that a distance d_{AE} between the center of a first antenna element and an adjacent antenna unit in said row is constant, and
wherein the multi-band antenna units comprise at least one first broadband antenna element and at least one second broadband antenna element arranged above or below said first broadband antenna element; and
at least one planar parasitic element arranged between said first and second broadband antenna elements,
wherein each of the first broadband antenna elements comprises a substantially planar conductive disc having at least four slots arranged symmetrically in relation to a central rotational axis (Z) perpendicular to said disc, wherein each slot extends from a circumference of said disc radially inwards towards said axis (Z) and has an associated feed point located at its associated slot; and radially opposite feed points are arranged to be fed with common radio frequency signals which are substantially in phase and with equal amplitude such that the radiation from each slot-is in phase and of equal amplitude so that said antenna element radiates along said axis (Z).

22. (canceled)
